(19) United States
(12) Patent Application Publication
(10) Pub. No.: US 2003/0004687 A1
(43) Pub. Date: Jan. 2, 2003

(54) Probe apparatus

(75) Inventor: Akira Seki, Tokyo (JP)

Correspondence Address: OLIFF & BERRIDGE, PLC, P.O. BOX 19928, ALEXANDRIA, VA, 22320, US

(73) Assignee: ANDO ELECTRIC CO., LTD., Tokyo (JP)

(21) Appl. No.: 10/160,040

(22) Filed: Jun. 4, 2002

(30) Foreign Application Priority Data
Jun. 18, 2001 (JP) 2001-183668

(51) Int. Cl. G06F 15/00

(52) U.S. Cl. 702/188

(57) ABSTRACT

A probe apparatus, includes: a monitor channel signal receiving section for receiving one monitor channel signal selected from a plurality of monitor channel signals which flow in a plurality of transmission paths on a network to be managed; a monitor signal analyzing section for analyzing the one monitor channel signal received by the monitor channel signal receiving section to grasp a status of one transmission path on the network to be managed; and a monitor channel signal selecting control section for controlling that another monitor channel signal to be received by the monitor channel signal receiving section is selected from the plurality of monitor channel signals in accordance with a control signal outputted based on the status of the one transmission path.

### BACKGROUND OF THE INVENTION

1. Field of the Invention

The present invention relates to a probe apparatus for being used in the Internet protocol based network management.

2. Description of Related Art

In general, the Internet protocol (IP) based network like as a Synchronous Optical Network (SONET) backbone, is composed of a group of network devices such as a rooter, a hub, a bridge, a switch and the like. The IP based network comprises a management station for monitoring and managing a data communication status among the network devices. The management station remotely monitors the status of the IP based network and the behaviors of the network devices by periodically polling a group of the network devices or a communication network in the IP based network to be managed.

A simple network management protocol (SNMP) is widely used as an interface between the management station and the IP based network to be managed. The SNMP is a protocol which is developed to monitor and manage the IP based network system. In other words, the management station monitors and controls the IP based network and processes a traffic statistics collecting operation or the like by exchanging messages based on the SNMP, with the IP based network. Furthermore, the management station grasps a performance and a security status on the IP based network.

The messages which are transmitted or received between the management station and the IP based network to be managed, are exchanged by using a series of numbers based on a common database. As a result, the massages become simple and clear. The common database is referred to as management information base (MIB) and is composed of an aggregate of objects having a hierarchical tree structure. Hereinafter, each of the objects is referred to as an MIB object. In detail, in the SNMP, each individual meaning of the MIB objects is designated in accordance with a hierarchy in which each of the MIB objects is stored and in accordance with a numeral number which is attached to each of the MIB objects, respectively. As a result, it is possible to deal with any combination of the network devices in the IP based network regardless of a kind of the network device and a structure of the IP based network.

In order to grasp the present status of the IP based network, the management station always carries out the maintenance of the IP based network, such as, reads out the management information base and updates the management information base. In other words, the management station exchanges each of the MIB objects as an SNMP message with the IP based network when the IP based network is operated. In this event, an apparatus for generating the SNMP message on the IP based network, is each of the network devices which are composed of the IP based network, or is a specific one for collecting and processing traffic statistic values. The specific apparatus is referred to as a probe apparatus. Furthermore, when each of the network devices exchanges the SNMP message with the management station, each of the network devices carries out the exchange of the SNMP message through the IP based network to be managed or through a specific cable.

With respect to the representative network management system according to an earlier development, three examples thereof will be explained in the concrete. That is, the example (1) in which the network station exchanges the SNMP message with each of the network devices through the IP based network, the example (2) in which the network station exchanges the SNMP message with each of the network devices through the specific cable, and the example (3) in which the probe apparatus is used, will be explained.

FIG. 6 shows a view for illustrating an example of the structure of the IP based network and three examples of the network management system. In FIG. 6, the IP based network 70 comprises network devices 71 to 79 which are connected to one another through cables. The network devices 71 to 79 are nodes in the IP based network 70 and are used as a passage point, a relay point, a branch point and a concourse point of an IP packet flowing in the IP based network 70. In the concrete, the network devices 71 to 79 correspond to the rooter, the hub, the switch and the like. The management stations X, Y, and Z are connected to the IP based network 70.

The management station X manages the network devices 71, 72 and 74 in the IP based network 70, and takes the management system based on the above-mentioned example (1). That is, the management station X is directly connected to the IP based network 70 to be managed and exchanges the SNMP message with each of the network devices 71, 72, and 74 by using a part of frequency band of the IP based network 70. In FIG. 6, a broken line denotes an SNMP link which is formed between the management station X and the network devices 71, 72, and 74.

In the above-mentioned example, each of the network devices 71, 72, and 74 collect or store information such as an amount of data transfer (traffic statistic value) in each predetermined time period, which is processed by themselves, and detected error information and the like. The stored information is converted into a MIB format. On the other hand, the management station X polls the network devices 71, 72 and 74 to require them to supply the management station X with the information, such as the traffic statistic value and information relating to the existence of the detected error. When the network devices 71, 72 and 74 are required by the management station X, the network devices 71, 72, and 74 transfers the required information to the management station X by using a function called an agent (by operation of software in general).

The management station Y manages a network device 78, and takes the management system based on the above-mentioned example (2). In FIG. 6, the management station Y does not directly join in communications on the IP based network 70 and is connected to the network device 78 through a management cable 80. The network device 78 generates the traffic statistic value and the information relating to the existence of the error at predetermined time intervals, in a similar manner described in the example (1). The network device 78 converts the above-mentioned information into the MIB format to store it therein. Furthermore, the network device 78 transmits the SNMP message to the management station Y in accordance with the requirement which is supplied from the management station Y. At that time, the SNMP message is transmitted and received between the network device 78 and the management station Y through the management cable 80.

The management station Z manages a communication status of the network devices 71 and 73 by using a probe apparatus 81, and takes the management system based on the above-mentioned example (3). In FIG. 6, the management station Z is connected to the probe apparatus 81 through a management cable 82. The probe apparatus 81 is connected to an optical coupler 83 which is disposed on a transmission path, through a cable 84. The optical coupler 83 is disposed on a transmission path on which two network devices 71 and 73 are connected to each other. The optical coupler 83 branches the transmission signals without influencing the communication contents which flow in the transmission path. The optical coupler 83 outputs the branched transmission signals to the probe apparatus 81.

The probe apparatus 81 extracts an IP packet in accordance with the signal acquired from the transmission path, and calculates the traffic statistic values in each predetermined time period. When the SNMP message is outputted from the management station Z to the probe apparatus 81, the probe apparatus 81 generates a message corresponding to the SNMP message, and outputs it to the management station Z.

In case of taking the management system based on the example (1) (management station X), an amount of the SNMP messages (SNMP packets) to be transferred, which are required for the management increases when the number of the network devices managed by the management station increases. That is, an amount of the SNMP packets to be transferred, which flow in the IP based network to be managed, increases. As a result, the following problems are caused.

At first, the load of a relay network device for relaying the communication between the management station and the network device to be managed, increases. In FIG. 6, the load of the network device 71 for relaying the communication between the management station X and the network device 72, or those of the network devices 71 and 73 which relay the communication between the management station X and the network device 74 increase.

Secondly, there is some possibility that the SNMP packets which are exchanged between the management station and each network device to be managed, are cancelled in the relay network device. In general, the SNMP packet for transmitting only the management information, has a lower priority lower than a normal communication packet to be transmitted among the network devices of the IP based network. Accordingly, as the traffic is congested on the IP based network, there is some possibility that the network devices cancel the SNMP packet on the basis of the priority which is set in each network device. As described above, there is a risk that the SNMP packets are cancelled, when SNMP messages are exchanged between the network devices and the management station through the IP based network.

In the third place, it is required for the network device to be managed to generate the SNMP packets for the management station as well as to carry out an original communication processing as a device on the IP based network. As a result, there is some possibility that an original performance of the network device to be managed deteriorates when the communication traffic increases in the network.

For the above reasons, like the management station X shown inn FIG. 6, the above-mentioned IP based network management method that the network device to be managed is loaded and that a frequency band of the operating IP based network is used, is disadvantageous, particularly, to a high-speed network.

According to the above-mentioned management system based on the example (2) (management station Y), it is possible for the management station to certainly obtain the stored information and the error information of one network device which is connected to the management station, without the influence of the relay network device. However, in the above-mentioned example (2), it is not possible for the management station to directly grasp the status of the network devices on the IP based network except one connected to the management station.

According to the above-mentioned management system based on the example (3) (management station Z), because the management station exchanges the SNMP massage with the probe apparatus through a cable for management, there is not a risk that the SNMP message is cancelled in the relay network device. Furthermore, it is possible to monitor the status of each network device without influencing the communications in the transmission path.

However, in the manage system using the probe apparatus shown in FIG. 6, because the transmission path on which the probe apparatus can collect the information, is predetermined, it is difficult to rapidly grasp the status of the traffic in the entire IP based network, which continually varies. For example, it is desired to change the positions of the transmission path to be monitored, with a lapse of time in accordance with the variation of the traffic in the IP based network. In this case, when the traffic is tracked at a plurality of positions to be monitored, in accordance with the variation of the status, it is necessary to locate the probe apparatuses at all of the expected positions to be monitored, respectively.

As described above, the management system according to the example (3) is not a rational one because it is necessary to provide the sufficient number of probe apparatuses, although it is possible to objectively obtain the precise management information. Further, it is not possible to deal with the dynamic variation of the IP based network. There is a problem that the IP based network cannot be efficiently managed nor cannot be efficiently divided during fault occurrence, when the IP based network is managed by the limited number of probe apparatuses.

### SUMMARY OF THE INVENTION

An object of the present invention is to rationally manage the IP based network in accordance with the variation of the status in the IP based network to be managed.

In order to accomplish the above-mentioned object, in accordance with the first aspect of the present invention, a probe apparatus for receiving a monitor signal from an optical channel selector, comprises:

a connecting member for connecting the optical channel selector through a predetermined communication line; and

a channel selecting signal outputting section for outputting a channel selecting signal to the optical channel selector.

According to the first aspect of the present invention, the channel selecting signal outputting section outputs the channel selecting signal to the optical channel selector. For example, it is possible that the probe apparatus transmits the optical channel selector to the optical channel selector for extracting a predetermined monitor signal from a plurality of monitor signals, in order to change the monitor signal to be extracted. Therefore, it is possible to change the monitor signal to be measured in case of necessity without measuring the statistic information of all of the monitor signals at the same time. Further, it is possible to realize a rational management in accordance with the variation of the status of the IP based network to be managed.

The probe apparatus may further comprise:

a remote control signal receiving section for receiving a remote control signal from an external section;

wherein the channel selecting signal outputting section outputs the channel selecting signal in accordance with the remote control signal received by the remote control signal receiving section.

According to the present invention, the probe apparatus outputs the channel selecting signal in accordance with the remote control signal which is supplied from the external section. For example, it is possible to output the channel selecting signal in accordance with the remote control signal which is supplied from an external section such as a management station, a terminal device or the like.

In accordance with the second aspect of the present invention, a probe apparatus, comprises:

an optical channel selector for selecting a monitor signal from a plurality of monitor signals; and

a control section for controlling the optical channel selector so as to suitably select the monitor signal.

According to the second aspect of the present invention, the probe apparatus comprises the optical channel selector and the channel selection of the optical channel selector can be controlled. Therefore, it is possible to manage all of the points on the IP based network without measuring all of the monitor signals on the IP based network at the same time, by changing the monitor signal to be measured in case of necessity, when the statistic information of the monitor signal is measured.

The probe apparatus may further comprise:

a remote control signal receiving section for receiving a remote control signal from one or more external sections;

wherein the control section controls the optical channel selector in accordance with the remote control signal received by the remote channel signal receiving section.

According to the present invention, the probe apparatus controls the channel selection in accordance with the remote control signal which is supplied from the remote control signal receiving section. That is, it is possible to determine the channel to be selected by the optical channel selector, in accordance with the remote control signal supplied from the remote control signal receiving section. Furthermore, it is possible to measure the statistic information of the monitor signal of the selected channel.

The remote control signal receiving section may comprise a plurality of connecting members for connecting the plurality of external sections, and receives anyone of the remote control signals outputted from the plurality of external sections.

According to the present invention, it is possible to control the channel selection in accordance with each remote control signal by receiving the remote control signals which are supplied from a plurality of external sections. For example, the probe apparatus of the present invention is connected to a management station for managing the IP based network, an external terminal device, and an operation device which can be operated by a supervisor, through communication lines. Thereby, it is possible to control the channel selection in accordance with the remote control signal which is supplied from any one of the above station and the devices.

In accordance with the third aspect of the present invention, a probe apparatus, comprises:

a monitor channel signal receiving section for receiving one monitor channel signal selected from a plurality of monitor channel signals which flow in a plurality of transmission paths on a network to be managed;

a monitor signal analyzing section for analyzing the one monitor channel signal received by the monitor channel signal receiving section to grasp a status of one transmission path on the network to be managed; and

a monitor channel signal selecting control section for controlling that another monitor channel signal to be received by the monitor channel signal receiving section is selected from the plurality of monitor channel signals in accordance with a control signal outputted based on the status of the one transmission path.

The probe apparatus may further comprise: a control signal outputted section for outputting the control signal based on the status of the one transmission path.

The control signal may be outputted from an external section which is external from the probe apparatus.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a block diagram for illustrating a configuration of a network management system according to the present invention;

FIG. 2 shows a view for illustrating an applicable example of the network management system shown in FIG. 1;

FIG. 3 shows an example of a channel changing signal;

FIGS. 4A and 4B show views for illustrating progress of traffic statistic values;

FIG. 5 shows a view of another example; and

FIG. 6 shows a view for explaining network management systems according to an earlier development.

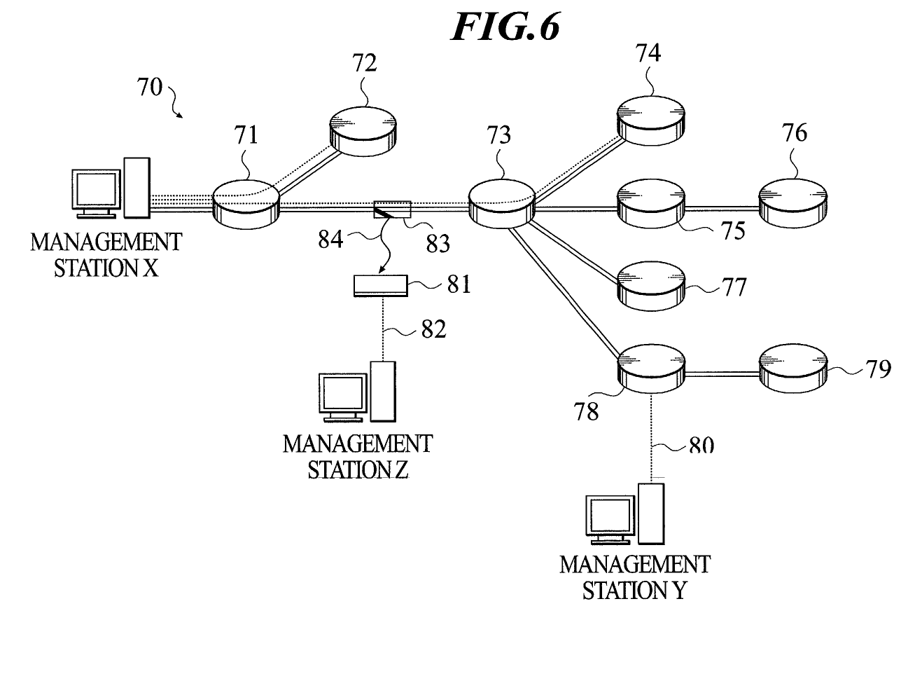

### PREFERRED EMBODIMENT OF THE INVENTION

Hereinafter, the preferred embodiment of the present invention will be explained with reference to the drawings. In the following description, a probe apparatus according to the present invention and the network management system using the probe apparatus will be explained in detail.

At first, the configuration of the probe apparatus will be explained.

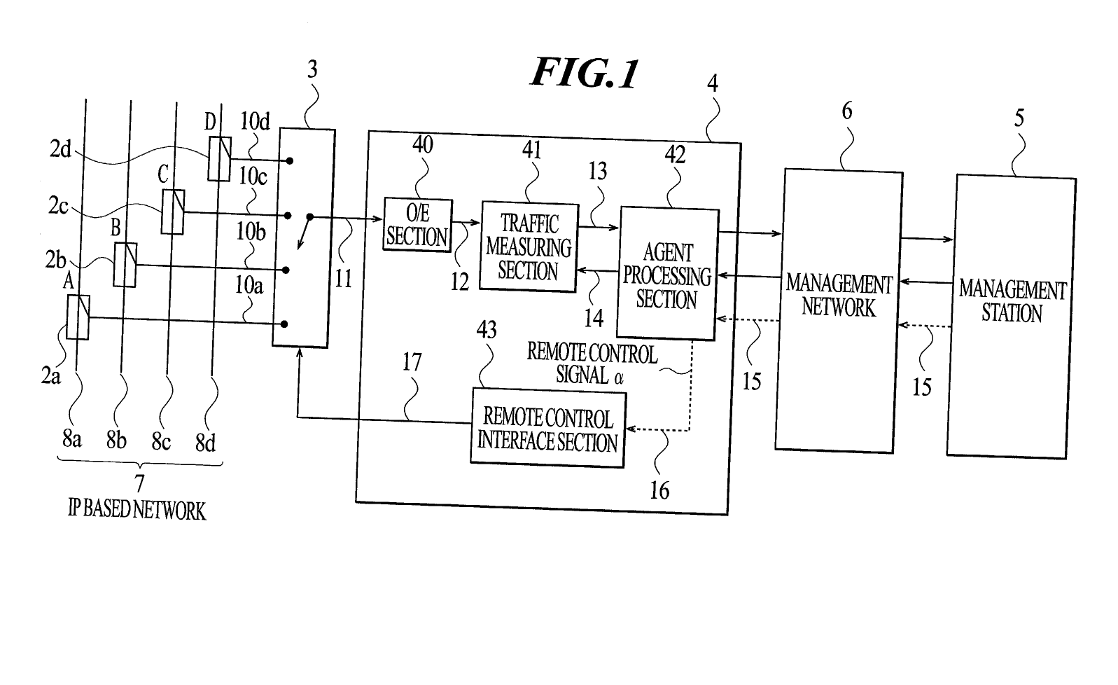

FIG. 1 is a block diagram for illustrating a configuration of a network management system 1. As shown in FIG. 1, the network management system 1 mainly comprises optical couplers 2a to 2d, an optical channel selector 3, a probe apparatus 4, and a management station 5. The optical couplers 2a to 2d are connected to the optical channel selector 3 through optical fiber cables, respectively. The probe apparatus 4 is connected to the management station 5 through a management network 6. The management network 6 is one which is different from an IP based network 7 to be managed.

The optical couplers 2a to 2d branch optical signals flowing in the optical transmission paths 8a to 8d, respectively, to transmit them to the optical channel selector 3 as monitor channel signals 10a to 1d. The optical couplers 2a to 2d are disposed at each monitoring point of the IP based network to be managed. According to FIG. 1, the optical coupler 2a is disposed at a monitoring point A of the IP based network 7. The optical coupler 2b is disposed at a monitoring point B. The optical coupler 2c is disposed at a monitoring point C. The optical coupler 2d is disposed at a monitoring point D. The optical couplers 2a to 2d transmit the branched monitor channel signals 10a to 10d to the optical channel selector 3, respectively.

The optical channel selector 3 receives the monitor channel signals 10a to 10d which are transmitted from all of the optical couplers 2a to 2d connected thereto. The optical channel selector 3 extracts one monitor channel signal 10 from a plurality of received monitor channel signals 10a to 10d. The optical channel selector 3 outputs the extracted monitor channel signal 10 as a network monitor input signal 11 to the probe apparatus 4. The optical channel selector 3 changes the optical channel signal to be extracted in accordance with a channel changing signal 17 which is outputted from a remote control interface section 43, when the optical channel selector 3 extracts the monitor channel signal 10.

The probe apparatus 4 processes traffic statistic information on the basis of the network monitor input signal 11 outputted from the optical channel selector 3. The probe apparatus 4 transmits the processed traffic statistic information to the management station 5. The probe apparatus 4 mainly comprises an O/E section 40, a traffic measuring section 41, an agent processing section 42, and the remote control interface section 43.

The O/E section 40 converts the network monitor input signal 11 outputted from the optical channel selector 3, into an electric signal 12, to output the converted electric signal 12 to the traffic measuring section 41.

The traffic measuring section 41 extracts an IP packet from the electric signal 12 which is converted by the O/E section 40. The traffic measuring section 41 calculates the traffic statistic values in each predetermined time period to generate the traffic statistic information. Further, the traffic measuring section 41 converts the generated traffic statistic information into an MIB format to generate traffic data 13 and to output it to the agent processing section 42 through a bus.

The agent processing section 42 has an interface function for the management station 5 which is connected thereto through the management network 6. The agent processing section 42 transmits and receives an SNMP packet. When a signal for requesting the traffic data 13 is outputted from the management station 5, the agent processing section 42 converts the traffic data 13 outputted from the traffic measuring section 41, into packet information in accordance with the SNMP, in order to transmit the packet information to the management station 5. Further, the agent processing section 42 generates a control signal 14 based on the content of instruction or inquiry signal which is received from the management station 5. The control signal 14 is outputted from the agent processing section 42 to the traffic measuring section 41. Furthermore, the agent processing section 42 generates a remote control signal 16 to output it to the remote control interface section 43 when a remote control packet 15 is transmitted from the management station 5.

The remote control interface section 43 generates the channel changing signal 17 in accordance with the remote control signal 16 outputted from the agent processing section 42, to transmit it to the optical channel selector 3. As shown in FIG. 1, when the optical channel selector 3 is arranged as an independent casing from the probe apparatus 4, a GP-IB interface (IEEE-488) or any one of serial interfaces is used for the channel changing signal 17 so as to adapt it for the optical channel selector 3 to be used.

The management station 5 is one for managing the IP based network 7 on the basis of the SNMP packet transmitted from the probe apparatus 4. More specifically, the management station 5 requires the agent processing section 42 to transmit the traffic data 13 to collect the traffic data 13. The management station 5 grasps the status of the IP based network 7 on the basis of the collected traffic data 13.

Further, the management station 5 transmits the remote control packet 15 to the agent processing section 42. The management station 5 may automatically carryout the transmission process of the remote control packet 15 on the basis of an analysis result of the traffic data. Alternatively, the management station 5 may carry out the above transmission process on the basis of an instruction inputted by a supervisor.

Next, an applicable example of the probe apparatus 4 will be explained.

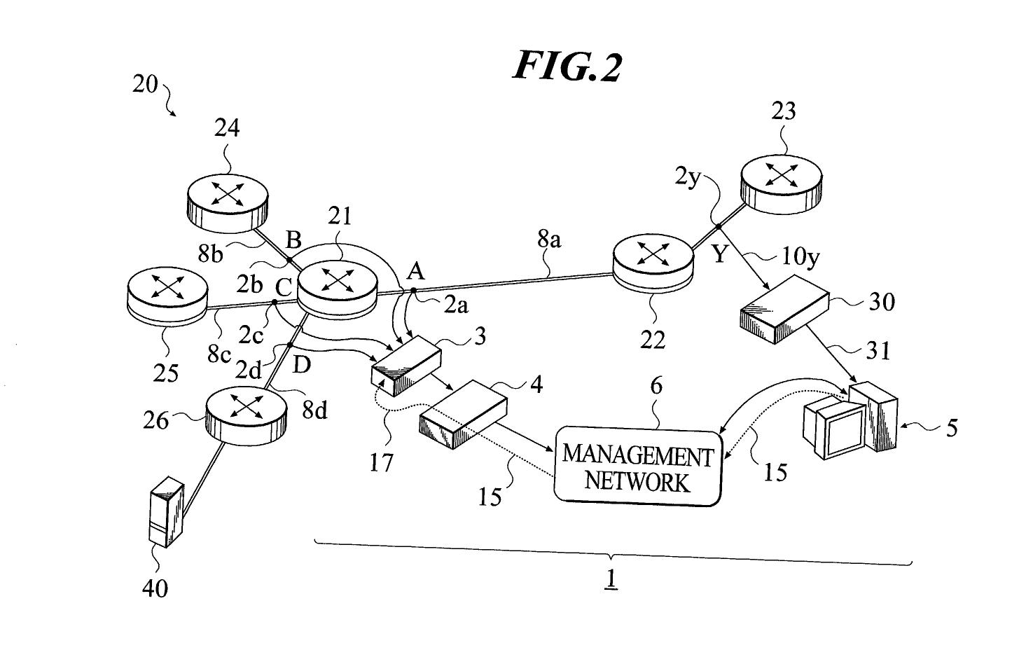

FIG. 2 shows a view for illustrating an example in which the network management system 1 is applied to the IP based network 20 to be managed. According to FIG. 2, the IP based network 20 comprises two core rooters 21 and 22 and four edge rooters 23 to 26. The optical coupler 2a is disposed at the monitor point A on the optical transmission path 8a by which core rooters 21 and 22 are connected to each other. The optical coupler 2b is disposed at the monitor point B between the core rooter 21 and the edge rooter 24. The optical coupler 2c is disposed at the monitor point C between the core rooter 21 and the edge rooter 25. The optical coupler 2d is disposed at the monitor point D between the core rooter 21 and the edge rooter 26. An optical coupler 2y is disposed at a monitor point Y between the core rooter 22 and the edge rooter 23. The edge rooter 26 is connected to an Internet Service Provider (ISP) apparatus 40.

A probe apparatus 30 is a probe apparatus according to an earlier development. Hereinafter, it is referred to as “earlier-developed probe apparatus”. The earlier-developed probe apparatus 30 is connected to the management station 5 through a management interface 31. The earlier-developed probe apparatus 30 stores the traffic data between the core rooter 22 and the edge rooter 23 on the basis of the monitor channel signal 10y which is branched by the optical coupler 2y to input it thereinto. Then, the earlier-developed probe apparatus 30 transmits the traffic data to the management station 5 through a cable 31.

The probe apparatus 4 is one according to the present invention. The probe apparatus 4 comprises a configuration explained with reference to FIG. 1 and is connected to the optical channel selector having an independent casing. Further, the optical channel selector 3 is connected to the optical couplers 2a to 2d. That is, the probe apparatus 4 comprises the optical channel selector 3 having four input ports which correspond to the input signals of the optical couplers 2a to 2d. The probe apparatus 4 monitors the communications at the monitor points A to D where the optical couplers 2a to 2d are disposed.

Further, the probe apparatus 4 is connected to the management station 5 through the management network 6. That is, the probe apparatus 4 generates the traffic statistic information on the basis of the network monitor input signal 11 which is transmitted from the optical channel selector 3. The probe apparatus 4 converts the traffic statistic information into the information based on the SNMP to store it therein. The probe apparatus 4 transmits the stored information as the SNMP packet to the management station 5 in accordance with the requirement signal transmitted from the management station 5. Furthermore, the probe apparatus 4 generates the channel changing signal 17 to output it to the optical channel selector 3 when the probe apparatus 4 receives the remote control packet 15 which is transmitted from the management station 5.

Hereinafter, it is assumed that a default monitor point of the optical channel selector 3 is the monitor point A. When the channel changing signal 17 is not received from the probe apparatus 4 by the optical channel selector 3, the optical channel selector 3 always extracts the monitor channel signal at the monitor point A between the core rooters 21 and 22. When the channel changing signal 17 is received from the probe apparatus 4, the channel of the optical selector 3 is changed from the monitor point B to the monitor point D between the core rooter 21 and the edge rooters 24 to 26.

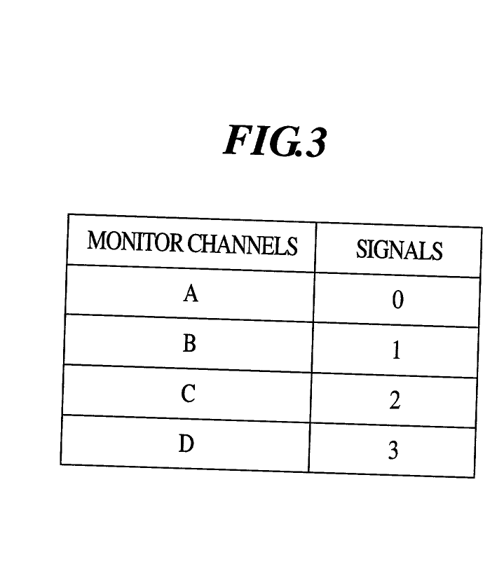

In order to simplify the explanation in the following description, the channel changing signal 17 is a 2 bit signal. FIG. 3 shows a table for illustrating an example of the channel changing signal 17. According to the table, the optical channel selector 3 selects the monitor channel signal outputted from the optical coupler 2a when the channel changing signal 17 represents “0”. Similarly, the optical channel selector 3 selects the optical coupler 2b when the channel changing signal 17 outputted from the probe apparatus 4 represents “1”. When the channel changing signal 17 represents “2”, the optical channel selector 3 selects the optical coupler 2c. When the channel changing signal 17 represents “3”, the optical channel selector 3 selects the optical coupler 2d.

The case in which the IP based network 20 is managed by using the earlier-developed probe apparatus 30 and the probe apparatus 4 according to the present invention, is explained. In the following description, it will be assumed that the traffic statistic value sharply increases with a lapse of time at the monitor point Y where the earlier-developed probe apparatus 30 monitors communication and that the traffic statistic value exceeds a predetermined threshold value SL.

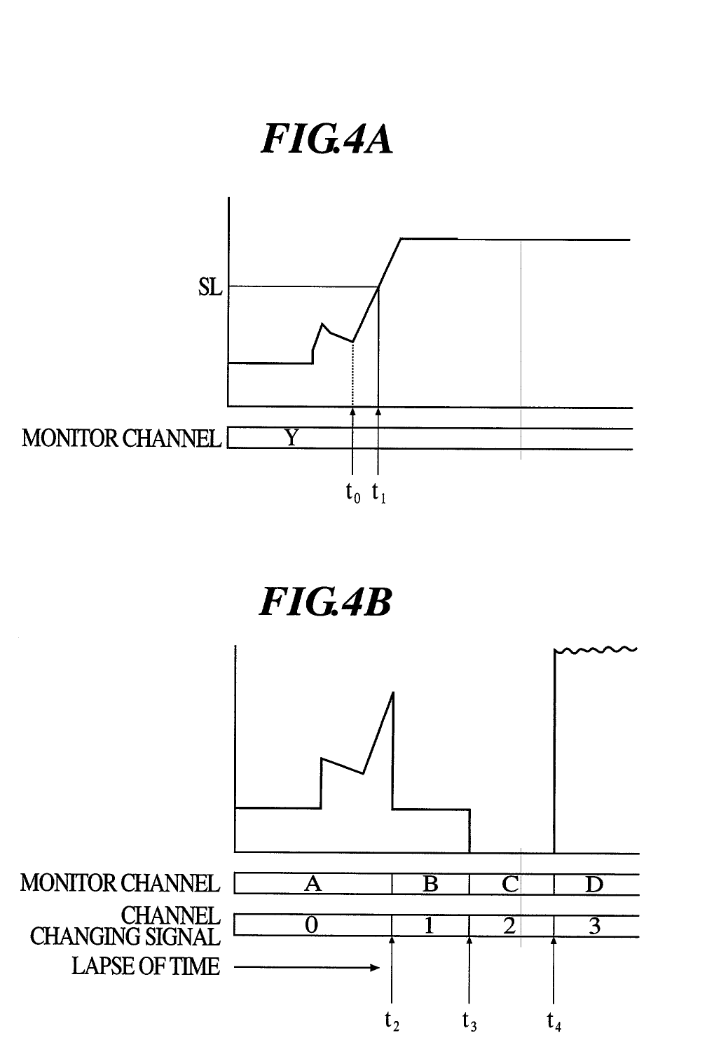

FIGS. 4A and 4B are graphs for illustrating the variation of the traffic statistic value as a function of a lapse of time. FIG. 4A shows the variation of the traffic statistic value which is detected by the earlier-developed probe apparatus 30. FIG. 4B shows the variation of the traffic statistic value which is detected by the probe apparatus 4. In FIGS. 4A and 4B, an abscissa axis represents a lapse of time. An ordinate axis represents a traffic amount of the IP packet per unit time.

In FIG. 4A, the traffic statistic value detected by the earlier-developed probe apparatus 30 at the monitor point Y sharply increases at the time t₀ to and reaches the threshold value SL at the time t₁. In order to search the cause of the trouble, the management station 5 stops the collecting process for the traffic statistic information at the monitor point A, which the probe apparatus 4 carries out in an initial state. Then, the management station 5 transmits the remote control packet 15 to the probe apparatus 4 so that the probe apparatus 4 carries out the collecting process for the traffic statistic information at the monitor point B. The agent processing section 42 of the probe apparatus 4 receives the remote control packet 15 to generate the remote control signal 16 and to output it to the remote control interface section 43. The remote control interface section 43 outputs the channel changing signal 17 representing “1”, to the optical channel selector 3.

In FIG. 4B, the traffic statistic value at the monitor point B does not correspond to the traffic statistic value at the monitor point Y since the time t₂. The management station 5 outputs, to the probe apparatus 4, the remote control packet 15 for changing the monitor channel from the monitor point B to the monitor point C. The remote control interface section 43 outputs the channel changing signal 17 representing “2”, to the optical channel selector 3.

However, in FIG. 4B, the traffic is not observed at the monitor point C. It is found that few packet is inputted into or outputted from the edge rooter 25 since the time t₃. The management station 5 further transmits, to the probe apparatus 4, the remote control packet 15 for changing the monitor channel from the monitor point C to the monitor point D. The remote control interface section 43 outputs the channel changing signal 17 representing “3”, to the optical channel selector 3.

When the monitor channel is changed to the monitor point D, it is judged that a traffic trouble observed at the monitor point Y is caused by exchanging a large amount of IP packets between the edge rooter 26 and the core rooter 21, as shown in FIG. 4B. By checking the edge rooter 26 shown in FIG. 2 in accordance with the result of the monitoring and by tracing the route of the traffic, for example, the problems in the ISP apparatus 40 can be found.

As described above, it is possible to rapidly detect a cause of the traffic trouble in comparison with the monitor system according to an earlier development by using the optical channel selector and the probe apparatus according to the present invention in a process of tracing the cause that the traffic abnormally increases. Further, because the monitor channel signals branched by a plurality of optical couplers are switched by the optical selector to detect them, for example, it is possible to thoroughly obtain the traffic statistics at all of the set monitor points by monitoring the communications at the monitor points around the specific network device at each timing in the IP based network to be managed. More particularly, in case of the probe apparatus shown in FIG. 2, it is possible to obtain the traffic statistics at four points by using one probe apparatus 4 when the optical channels to be monitored are always changed in an order of points A, B, C, D, A, . . .

The present invention is not limited to the above-described embodiment, and may be applied to various modified embodiments. For example, in the above-described embodiment, the management station transmits the remote control packet 15 to the probe apparatus. The agent processing section 42 outputs the remote control signal 16 to the remote control interface section 43, so that the optical channel selector changes the monitor channel. However, the present invention is not limited to this. For example, a terminal device which is different from the management station may directly output the remote control signal to the remote control interface section 43. Alternatively, the supervisor may directly output the command to the remote control interface section 43 without using a remote control.

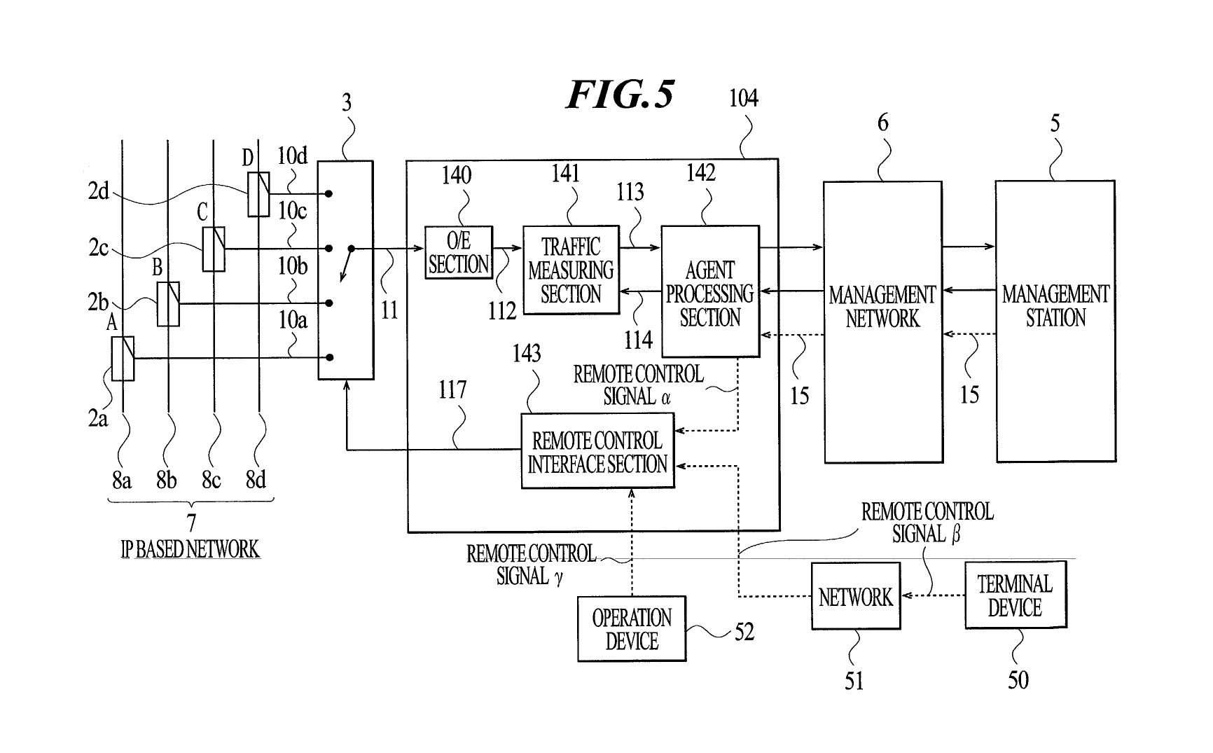

FIG. 5 shows an example for illustrating a configuration in which the probe apparatus 104 is connected to a terminal device 50 and an operation device 52. The probe apparatus 104 comprises an O/E section 140, a traffic measuring section 141, an agent processing section 142 and a remote control interface section 143. The reference numeral 112 denotes an electric signal into which the network monitor input signal 11 is converted by the O/E section 140. The reference numeral 113 denotes a traffic data, 114 denotes a control signal and 117 denotes a channel changing signal. The terminal device 50 is connected to the remote control interface section 143 of the probe apparatus 104 through a network 51. The operation device 52 is directly connected to the remote control interface section 143 by a cable. In FIG. 5, the remote control interface section 143 receives not only a remote control signal α outputted from the management station 5 through the agent processing section 142, but also a remote control signal β outputted from the terminal device 50 through the network 51, and a remote control signal γ outputted from the operation device 52. In such an embodiment, the remote control interface section 143 outputs the channel changing signal 117 to the optical channel selector 3 even when one of the remote control signals α to γ is inputted into the remote control interface section 143. In other words, the remote control interface section 143 has a function of wired OR for each bit of the remote control signals α to γ to carry out the same operation even when any one of the remote control signals α to γ is inputted.

Alternatively, the remote control interface section 143 gives a priority to each remote control signal. When two or more remote control signals are inputted into the remote control interface section 43 at the same time or in a short time, the remote control interface section 43 may compare one remote control signal with another to output the remote control signal having a superior priority as the channel changing signal 17. Alternatively, the operation device may comprise a switch for selecting a status that only the inputted remote control signal α or the inputted remote control signal β is effective, or a status that only the inputted remote control signal γ generated by the operation device is effective. That is, in accordance with the setting of the switch, the operation device may switch a status that the inputted remote control signal α or β which is transmitted from the management station or the terminal device is effective, or a status that the inputted remote control signal γ which is outputted from the operation device is effective.

In the embodiment of the present invention, the operation device 52 for generating the remote control signal γ is arranged so as to be independent of the prove apparatus. However, the operation device may be incorporated into the probe apparatus. Furthermore, in the embodiment, the optical channel selector is arranged so as to be independent of the probe apparatus. However, the optical channel selector may be incorporated into the probe apparatus. In the embodiment, the probe apparatus is connected to the terminal device 50 for generating the remote control signal β, through the network. However, the probe apparatus may be connected to the terminal device through a single cable.

According to the present invention, it is possible to control the monitor signal extracted from a plurality of monitor signals received by the optical channel selector. As a result, it is possible to select any one from all of the monitor signals on the IP based network to be managed, and to change the monitor signal to be measured in case of necessity.

The entire disclosure of Japanese Patent Application No. Tokugan 2001-183668 filed on Jun. 18, 2001 including specification, claims drawings and summary are incorporated herein by reference in its entirety.

What is claimed is:

1. A probe apparatus for receiving a monitor signal from an optical channel selector, comprising:
a connecting member for connecting the optical channel selector through a predetermined communication line; and
a channel selecting signal outputting section for outputting a channel selecting signal to the optical channel selector.

2. The probe apparatus as claimed in claim 1, further comprising:
a remote control signal receiving section for receiving a remote control signal from an external section;
wherein the channel selecting signal outputting section outputs the channel selecting signal in accordance with the remote control signal received by the remote control signal receiving section.

3. A probe apparatus, comprising:
an optical channel selector for selecting a monitor signal from a plurality of monitor signals; and
a control section for controlling the optical channel selector so as to suitably select the monitor signal.

4. The probe apparatus as claimed in claim 3, further comprising:
a remote control signal receiving section for receiving a remote control signal from one or more external sections;
wherein the control section controls the optical channel selector in accordance with the remote control signal received by the remote channel signal receiving section.

5. The probe apparatus as claimed in claim 4, wherein the remote control signal receiving section comprises a plurality of connecting members for connecting the plurality of external sections, and receives any one of the remote control signals outputted from the plurality of external sections.

6. A probe apparatus, comprising:
a monitor channel signal receiving section for receiving one monitor channel signal selected from a plurality of monitor channel signals which flow in a plurality of transmission paths on a network to be managed;
a monitor signal analyzing section for analyzing the one monitor channel signal received by the monitor channel signal receiving section to grasp a status of one transmission path on the network to be managed; and
a monitor channel signal selecting control section for controlling that another monitor channel signal to be received by the monitor channel signal receiving section is selected from the plurality of monitor channel signals in accordance with a control signal outputted based on the status of the one transmission path.

7. The probe apparatus as claimed in claim 6, further comprising: a control signal outputted section for outputting the control signal based on the status of the one transmission path.

8. The probe apparatus as claimed in claim 6, wherein the control signal is outputted from an external section which is external from the probe apparatus.
